(19) United States
(12) Patent Application Publication
(10) Pub. No.: US 2008/0053733 A1
(43) Pub. Date: Mar. 6, 2008

(54) Device and method for stretching a transmission chain

(76) Inventors: Jacobus Hubertus Maria Van Rooij, BA Nuenen (NL); Johannes Henricus Nelissen, ZS Helmond (NL)

Correspondence Address: DUANE MORRIS LLP, Suite 700, 1667 K Street, N.W., Washington, DC, 20006, US

(21) Appl. No.: 11/896,062

(22) Filed: Aug. 29, 2007

(30) Foreign Application Priority Data
Aug. 30, 2006 (NL) 1032385

(51) Int. Cl. B62M 9/16

(52) U.S. Cl. 180/231

(57) ABSTRACT

The invention provides a device for stretching a transmission chain which is closed in itself and is made up from a number of adjacent links which are, in the longitudinal direction of the chain, mutually intercoupled by pairs of longitudinal rocker elements and in which the ends of at least one rocker element operate torque transmittingly with the pulley sheaves of a 5 pulley sheave transmission, said device comprising at least two supporting surfaces lying at a distance of each other and supporting the chain according to an arc, and provided with means to generate in this chain a tensile force leading to a surpassing of the limit of elasticity of the link material.

To improve the stretching and more particularly to prevent an uncontrolled bending of 10 the rocker elements during the treatment of the chain with all drawbacks thereof the invention proposes that at least one of the supporting surfaces is configured to support the radial inner area of at least a part of the chain. Thus bending of the rocker elements is prevented and the treatment of the chain is improved considerable.

### BACKGROUND OF THE INVENTION

The invention relates to a device for stretching a continuous transmission chain having a number of adjacent links which are intercoupled in the longitudinal direction of the chain by pairs of longitudinal rocker elements in which the respective ends of at least one rocker element of each pair cooperate in a torque transmitting way with pulley sheaves of a pulley sheave transmission, said device comprising at least one first and one second supporting surface which lie at a distance from each other and support a chain to be treated at least partially along an arcuate path, and having means to generate in this chain tensile stresses of such magnitude that the limit of elasticity of the material of the links is at least locally surpassed. The invention also relates to a method for stretching such a transmission chain.

### DISCUSSION OF THE PRIOR ART

Increasing the strength of the material of the links of an endless transmission chain by stretching while (locally) surpassing the limit of elasticity of this material in order to improve the properties of the chain is a known method described in 1966 in an article by Dr. Ing. Otto Dittrich, published in February 1966 in VDI Zeitschrift 108. A transmission chain which can be treated in this way for instance, is a chain described in U.S. Pat. No. 5,728,021 (van Rooij) and US 2006/030442 A1 (van Rooij).

Furthermore, U.S. Pat. No. 6,824,484 describes how this method can be implemented using two sets of conical sheaves, between which the rocker elements of a chain to be treated are accommodated and which are each clamped by means of its corresponding control system of a conventional continuous variable transmission. The Dutch Patent Specification 1 018 594, corresponding therewith, also documents this prior art.

The use of this known set of conical sheaves is the most obvious solution to the problem of how to support a transmission chain of the kind referred to above while stretching it. The known method and the apparatus used for this solution have a number of drawbacks and imperfections. Mounting the chain between the conical sheaves is time consuming, and the shape and dimension of the surfaces of these conical sheaves must be accurately adapted to the shape and the dimension of the protruding ends of the rocker pins of the chain and particularly to the configuration of the end surface of the pins, which is commonly curved in two directions. The most important drawback, however, lies in the fact that the loading of the rocker pins and of the links as well during the stretching of the chain is totally different from the loading which occurs in the chain during the normal operation thereof. There will occur an uncontrolled bending of the rocker pins so that the rocker pins which cooperate with the edges of the openings in the link will load the material around theses edges in a way which is quite different from the loading which occurs during normal operation. It is, in fact, impossible to define the local plastic deformation which occurs during such a pre-loading of the link material exactly so that, when this operation is finished, one does, in fact, know that certain parts of the link have been loaded beyond the limit of elasticity but one does not know accurately which parts these are and how far they are loaded. A check of the treated chains later on is, of course, impossible, so that a manufacturer who delivers chains treated in such a way is, in fact, never sufficiently sure about the quality thereof and cannot guarantee that a certain chain meets the requested specifications, unless the chain is over-designed with a higher safety margin. This, however, leads to higher costs, waste of material and greater dimensions of the chain.

Furthermore U.S. Pat. No. 4,515,576 discloses a continuously variable transmission having on the one hand a pair of adjustably pulley sheaves and on the other hand a relatively wide toothed gear wheel. A so-called “silent chain” comprising toothed links, is slung over this gearwheel while pressure pads fixed to the outermost links are clamped between the pulley sheaves. The teeth of the links rest in the shallow spaces between the teeth of the gearwheel and the chain is tensioned by means of a pressure roller.

There is no indication in this disclosure that the chain is ever to be tensioned in such a way that the links are loaded beyond their limit of elasticity and, indeed, if they should be loaded in such a way, the results which are obtained by means of the invention cannot be realized because the links of the chain are supported by the summits of the triangular parts thereof so that the resulting stresses in the links are directed in an incorrect direction and have no beneficial effect.

U.S. Pat. No. 1,966,831 discloses a kind of similar transmission in which every other link is provided at both its ends with a downwardly directed lug of which the end surface rests against the side of a tooth of the gearwheel. Pressure members protruding through the bodies of the pins cooperate with the surfaces of the pulley sheaves. Here, too, nothing in the disclosure hints at any beneficial loading of the chain and the stresses introduced into the links by the cooperation of the lugs with the gear teeth are not directed in the correct direction to have any beneficial effect on the links.

### SUMMARY OF THE INVENTION

The invention aims to obviate these drawbacks of the prior art such as outlined above. To this end the invention proposes that at least one of the supporting surfaces is configured to support the radial inner area of at least a part of the chain, such that essentially only stresses running in the longitudinal direction of the respective links are generated in these links.

With these measures, any bending of the rocker pins—which are now not supported anymore on their ends—is positively prevented so that all the drawbacks and disadvantages related thereto do not occur anymore.

Preferably at least one supporting surface is configured to support the radial inner edges of at least a part of the links.

The supporting surface can then be configured in such a way that a link with a hollow end edge configuration is supported in two points which lie at a distance of each other.

The supporting surface is preferably at least a part of the outer surface of a cylinder and this outer surface is convexly or concavely curved.

In another preferred embodiment at least one supporting surface is built up to form a number of partial support surfaces, each configured to support at least a part of the radial inner end edge of at least one rocker element of each pair of rocker elements out of a number of adjacent rocker elements as seen in the longitudinal direction of the chain so that the rocker elements and not the links, are supported between the ends of the rocker elements.

In that case, each partial support surface can be made up from an end edge of a plate-shaped finger of which the thickness is adapted to the interspace which is present between adjacent links. The finger, in combination with a number of similar fingers, protrudes radially from the outer surface of a common rotatingly supported bearer. The positioning pattern of these fingers is adapted to the configuration of the link packets of the chain.

In a preferred embodiment the respective blade-shaped fingers each protrude from the outer circumference of a ring-shaped bearer made from plate material which together constitute the support surface. A number of these ring-shaped bearers are, together with interpieces of suitable thickness, stacked into a unit which is carried by a central shaft on which the circumferential distances between adjacent fingers are adapted to the predefined and known distribution of the pitch of a chain to be treated.

The invention also provides a method for stretching a continuous transmission chain having a number of adjacent links which are intercoupled in the longitudinal direction of the chain by pairs of longitudinal rocker elements in which the respective ends of at least one rocker element can cooperate in a torque transmitting way with pulley sheaves of a pulley sheave transmission, using at least one first and one second supporting surface which lie at a distance from each other to support a chain to be treated at least partially along an arcuate path to generate in this chain tensile stresses of such a magnitude that the limit of elasticity of the material of the links is at least locally surpassed, while supporting the radial inner area of at least a part of the chain. In executing this method the inner end edges of a number of links adjacent each other in the longitudinal direction of the chain can be supported according to an arcuate surface, while then at least part of the respective inner end edges of at least one rocker element of each pair are supported according to an arcuate supporting configuration.

### DESCRIPTION OF THE DRAWING

FIG. 1 is a side view an embodiment of a chain to be preloaded, in which the links are supported on the inner end edges thereof by a support surface.

FIG. 2 is an enlarged scale view of FIG. 1.

FIGS. 3a-3e shows five different possible embodiments according to the invention. FIG. 4 is an enlarged scale view of the embodiment according to FIG. 3a.

FIG. 5 is an enlarged scale view of the embodiment according to FIG. 3b.

FIG. 6 is another embodiment according to the invention.

FIG. 7 is an embodiment in which the rocker pins of a chain to be pre loaded are directly supported by blade-shaped supporting fingers.

FIGS. 8a-8c show cross-section, lower end view and end view, respectively, of the configuration of a chain to be preloaded by means of the embodiment according to FIG. 7;

FIG. 9 is an upper end view an embodiment having a supporting core with supporting fingers.

FIG. 10 is a side view of the embodiment of FIG. 9.

FIG. 11a is a cross-section of a core with supporting fingers, built up from a stack of individual plates.

FIG. 11b is an upper end view of the core of FIG. 11a.

FIGS. 12a, 12b and 12c show side views of the plates of FIGS. 11a and 11b.

FIG. 13 is an end view of three supporting rollers for a chain to be preloaded.

FIG. 14 shows a complete device, constructed in accordance with the principle shown in FIG. 13.

FIG. 15 shows the way in which an endless transmission chain such a chain treated by a device according to the invention, co-operates with a pair of conical pulley sheaves.

### DESCRIPTION OF EMBODIMENTS

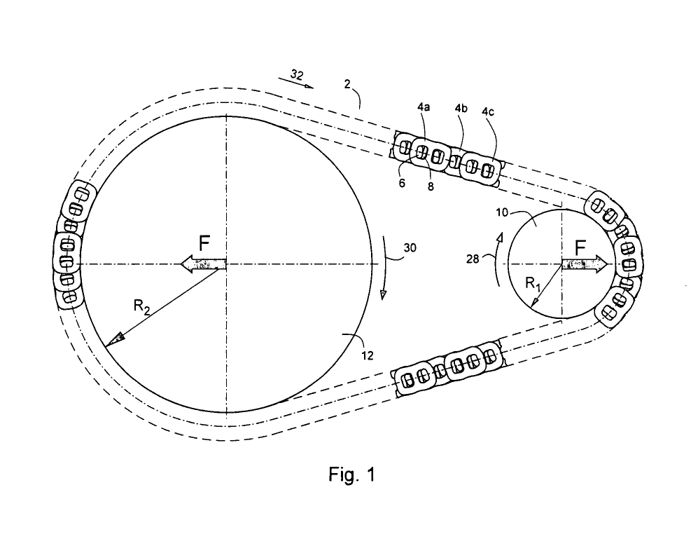

In FIG. 1 reference numeral 2 refers to an endless transmission chain built up from individual links such as indicated with reference numerals 4a, 4b, 4c which are mutually coupled by pairs of pin-shaped rocker elements; two of such elements are in the figure indicated with reference numerals 6 and 8 respectively. Such a chain is known from EP a 741 255 BI in the name of applicant, which is hereby incorporated herein.

To subject this chain to a pre-loading treatment so that the material of the links is stretched beyond the limit of elasticity thereof, the chain is guided around two cylindrical supporting rollers having different respective diameters, namely a first supporting roller 10 with radius R1 and a second supporting roller 12 with preferably a greater radius R2. Both the supporting rollers are pressed away from each other with a force indicated by F so that such stresses are generated in the chain 2 at the link material around the link openings, namely the area where the pins contact the links is subject to compressing stresses and will deform plastically, so that the strength of this material is permanently increased.

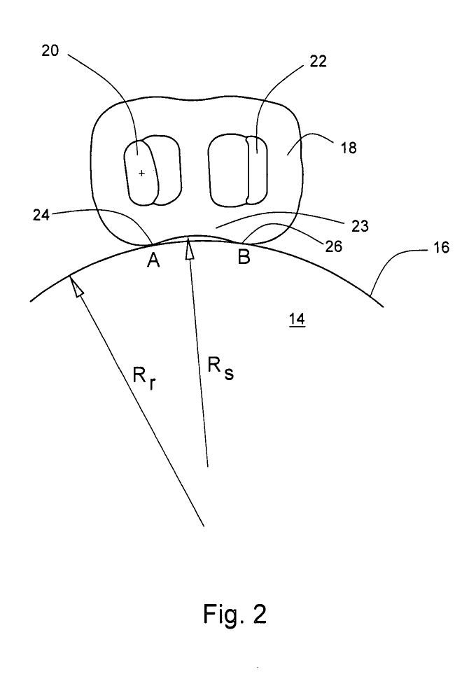

As discussed previously, the use of pre-loading is known from the prior art. However, contrary to the way of supporting the chain as known from U.S. Pat. No. 6,824,484 and the Dutch Patent Specification 1 018 594 respectively, in which the chain is supported by means of the ends of the rocker elements 6, 8 which are supported by the Vshaped supporting surfaces of the pulley sheaves of a common continuously variable transmission with all the disadvantages which go therewith as described hereinbefore, the present invention proposes to locate this support at the radial inner areas of the chain. In a first embodiment, shown in FIG. 1-6, this is done so that the radially inner edges of the respective links rest, during their travel over cylindrical rollers, such as the rollers 10-12 in FIG. 1, on the outer surface of these rollers, in the way as shown in FIG. 2. FIG. 2 shows a supporting roller 14 with a radius of curvature Rr and a link 18 which rests upon the outer surface 16 thereof; this figure also shows the rocker pins 20 and 22 respectively. As shown, the configuration of the lower link surface 23 presents a hollow, concave portion with radius of curvature Rs, bounded by two convex edge parts 24 and 26 respectively. The drawing shows the state in which the end edges of these edge parts 24, 26 rest on the roller surface 16. In an optimal situation, the radius of curvature Rr of the supporting roller 14 is equal to the radius of curvature Rs of this hollow part—the lower link circumference then lies fully against the outer surface and the contact stresses are minimal.

During the preloading, the rollers 10 and 12 respectively rotate along their respective axes in the direction of the arrows 28 and 30 respectively so that the chain will move in the direction of the arrow 32.

In the embodiment according to FIG. 1 the tensile forces in the chain 2 are generated when the rollers 10 and 12 respectively are pressed away from each other with a defined force F.

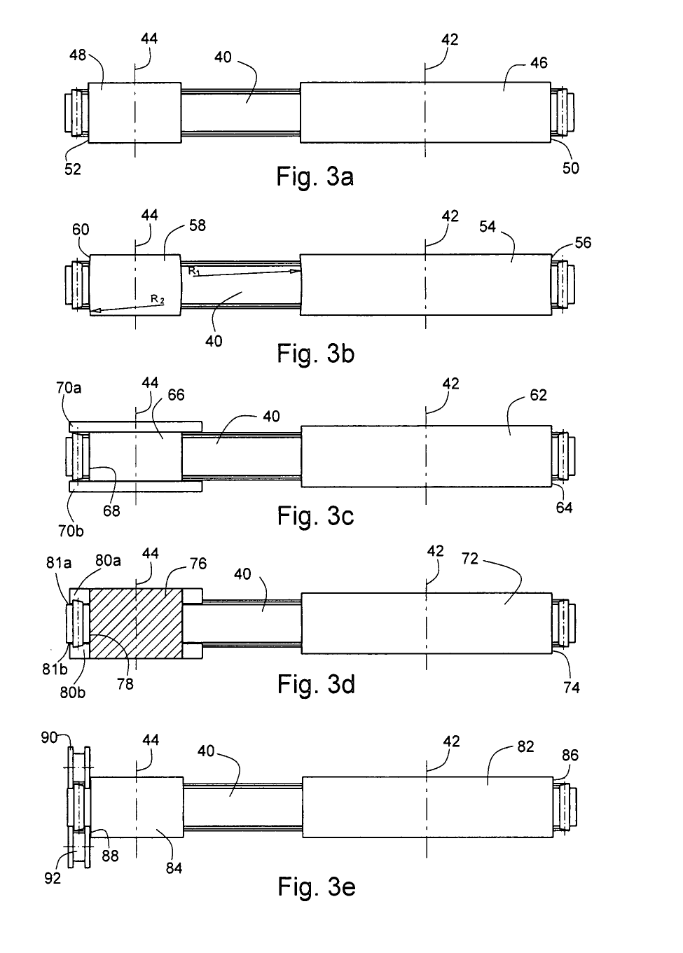

FIGS. 3a-3e show examples of configurations of supporting rollers in which a supporting roller with relatively great diameter is shown on the right hand side and a supporting roller with small diameter on the left hand side. The chain to be treated is in these five drawings is indicated with the same reference numeral, namely reference numeral 40; the axis (axis of rotation) of the right hand roller is indicated with 42 and same of the left hand roller with 44.

FIG. 3a shows an embodiment in which the right hand roller 46 and the left hand roller 48 both have a circle-cylindrical outer surface, indicated with 50 and 52 respectively.

FIG. 3b shows an embodiment in which the right hand roller 54 has a concave outer surface 56 and the left hand roller has a convex outer surface 60. The radius of curvature of the surface 56 is indicated with R1 and the radius of curvature of surface 60 with R2.

Of course combinations of the above described configurations are possible, thus a combination in which a roller with a convex or concave outer surface is combined with a cylindrical roller is contemplated. All these combinations depend upon the distribution of the loading which one wants to effect in the links.

FIG. 3c shows a right hand roller 62 with a circle-cylindrical outer surface 64 while the left hand roller 66 has a cylindrical supporting surface 68 bounded by to guiding flanges 70a, 70b.

FIG. 3d shows two supporting rollers, the right hand one, 72, with a cylindrical supporting surface 74 and the left hand one, 76, shown in cross-section also with a cylindrical supporting surface 78 which is bounded by guiding flanges 80a, 80b, which enclose the chain locally and support it, namely at the position of the links which lie at the outer edges 81a, 81b of the chain 40.

Finally FIG. 3e shows an embodiment in which both the right hand roller 82 and the left hand roller 84 has a cylindrical supporting surface 86 and 88 respectively (in this respect this embodiment is the same as the one according to FIG. 3a), but in which the left hand roller 84 is combined with two guide rollers 90, 92 with flanges to guide the chain 40 enclosed therein between.

FIG. 4 shows in more detail an embodiment corresponding to the one which is shown in FIG. 3a. Here is shown the big supporting roller 100 with cylindrical supporting surface 102, and rotatingly supported by the shaft 104, as well as the smaller supporting, roller 106, also with a cylindrical supporting surface 108 and supported by the shaft 110. The chain which is to be stretched is indicated with 112 and this figure shows clearly how this chain is built up in the known way, from links packets 114 coupled by rocker assemblies 116 which each comprise a longer pin 118 which, during use of the chain in a CVT cooperates with the pulley surfaces thereof and a shorter rocker pin 120 which cooperates with the pin 118.

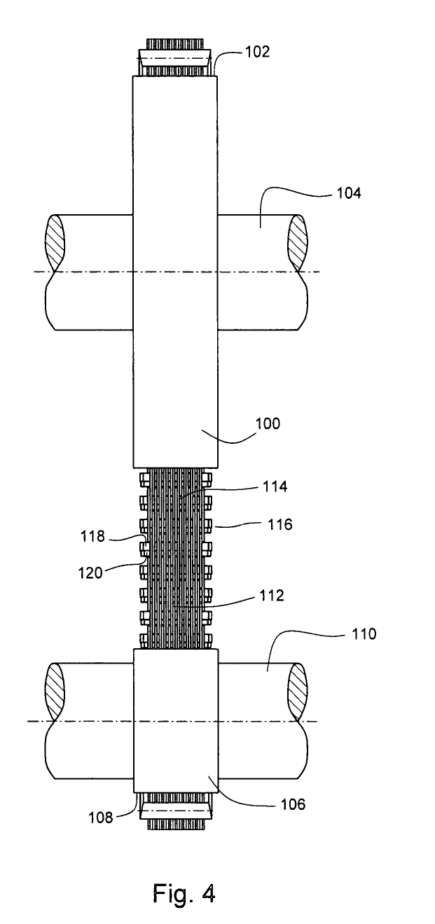

FIG. 5 shows a similar configuration but here the bigger roller 100a has a concave supporting surface having a radius of curvature Rh while the smaller roller 106a has a convex supporting surface 108a with radius of curvature Rc.

During the stretching of a chain it is important that the chain remains very well centered on the outer surfaces of the respective rollers. When the outer surface of one of these rollers is convex there will be, as known in itself, a self-centering effect so that one need not fear that the chain will run off the roller. Examples of a cross-guiding of the chain are already given in the FIGS. 3c, 3d and 3e.

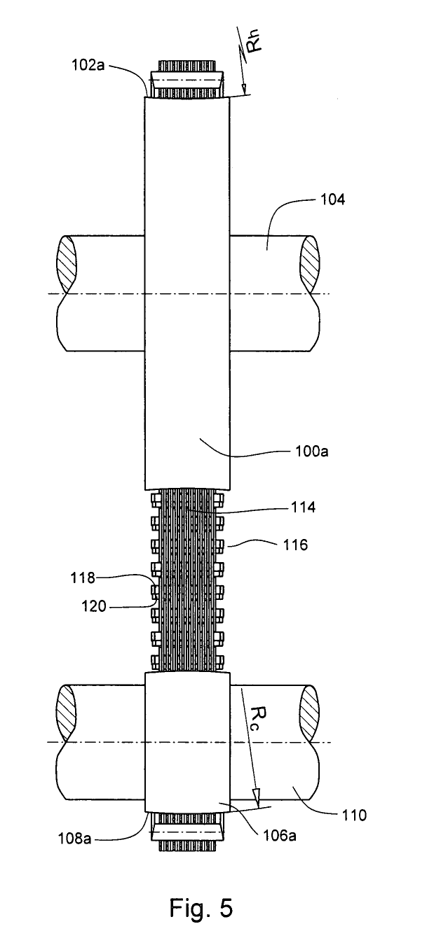

FIG. 6 shows a favorable way of guiding the chain using the centering of the pinshaped rocker elements thereof by means of conical guiding surfaces which cooperate with these pins. FIG. 6 shows a first supporting roller 130 with relatively great diameter, fixed to the rotating shaft 132 and having a cylindrical outer surface 134; this surface 134 is enclosed by two guiding flanges 136 and 138 respectively with conical guiding surfaces 140 and 142 respectively. They enclose with a small play the protruding rocker pins 144 of the chain 146 which is to be preloaded. This play is indicted with d1 and d2 respectively. The other supporting roller 147 which is fixed to the shaft 148 also has a plane cylindrical supporting surface 150, here, too, this supporting surface 150 is enclosed by two flanges 152 and 154 with conical guiding surfaces 156 and 158 respectively which enclose the protruding pins 159 with a small play (indicated with d3 and d4 respectively.

In all embodiments described herein, one can use supporting rollers with a cylindrical, a convex or a concave configuration of the outer surface thereof and of every possible combination thereof so that any desired pattern of permanent stresses can be realized in a chain which has been subjected to the pre-loading treatment.

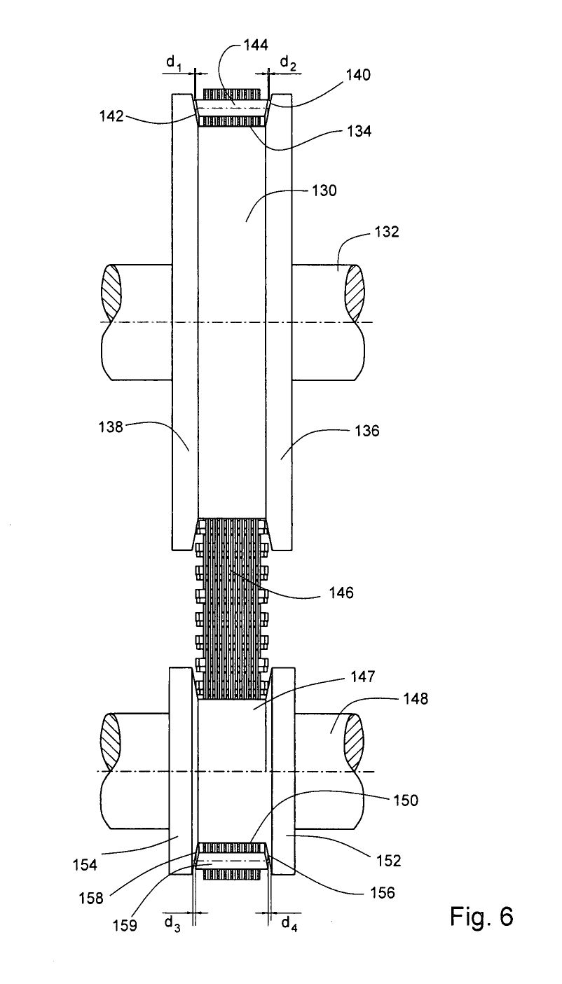

The embodiments previously described hereinbefore have in common the fact that within the scope of the general main idea of the application—the supporting of a chain to be preloaded on the inner area thereof—use is made of supporting rollers on which rest the inwardly directed end edges of the links. It is, however, also possible to use a configuration in which a chain to be preloaded is not supported under the end edges of the links but under the longitudinal end edges of the rocker pins which intercouple these links. Such an embodiment is shown in FIG. 7 to and including 14.

FIG. 7 shows a chain 160, which is also constituted of links 162 intercoupled by rocker assemblies 163; the latter consist each of a first pin 164 of which the ends, during use of the chain in a CVT, cooperate in a torque transmitting way with the surfaces of the pulley sheaves thereof, and second, shorter, pins 166. During the preloading the respective lower (inwardly directed) end edges of these pins (indicated with reference numerals 164a, 166a for the pins which are drawn in link 162) rest on the supporting end edges 168 of blade-shaped fingers 170 which protrude radially from a central core 172, which can rotate around the axis 174. The thickness of these blade-shaped fingers 170 is such that—as will be discussed—these fingers fit in the spaces which are always present between the link packets of a chain. So, for instance, after rotation in the direction of the arrow 165, the finger 170a will fit into the space which is present between the end parts of the links 162, 162a which are directed towards each other to support the pins of the rocker assembly 163a. This finger has a thickness which is just a little bit smaller than the thickness of the links. During the process of pre-loading, the rocker pins and not the links are supported at several positions simultaneously between the ends of the rocker pins but not at their ends. Thus, bending of the rocker pins is absolutely impossible.

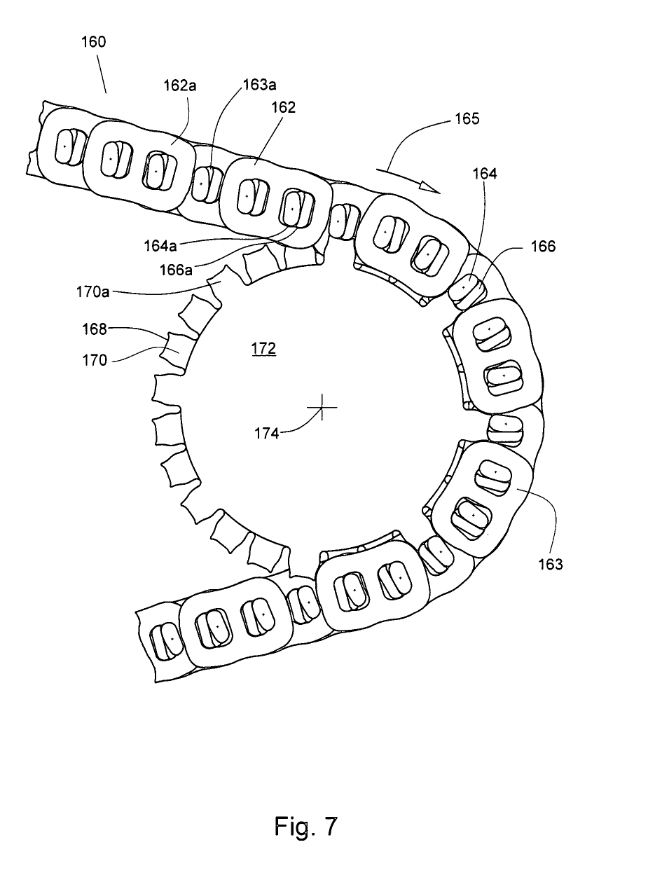

FIG. 8a shows a cross-section over the line IIXa-liXa in FIG. 8b of a chain 180 of which in this drawing a part is shown in an upper plan view while the same chain 180 is shown in FIG. 8c in a side view. The cross-section goes through the pin 182 which constitutes in combination with the cooperating pin 184 a rocker assembly 186.

As particularly shown in FIG. 8a, the individual links do not lie—as seen in the crossdirection of the chain, all against each other; there is in this case a space 230 between the links 202 and 204 and a space 232 between the links 204 and 206; a subsequent space 234 is to be found between the links 210 and 212 and a space 236 between the links 212 and 214; furthermore there is a space 238 between the links 218 and 220 and a space 240 between the links 220 and 222 while finally one finds a space 242 between the links 224 and 226 and a space 244 between the links 228 and 231. In these spaces the blade-shaped fingers 170 shown in FIG. 7 fit and ultimately these fingers come to lie against the under edges of the rocker elements such as the rocker elements 164a and 166a. The links have an assembly pattern which, as shown in FIG. 8b, repeats itself after every three rocker member assemblies, such as known.

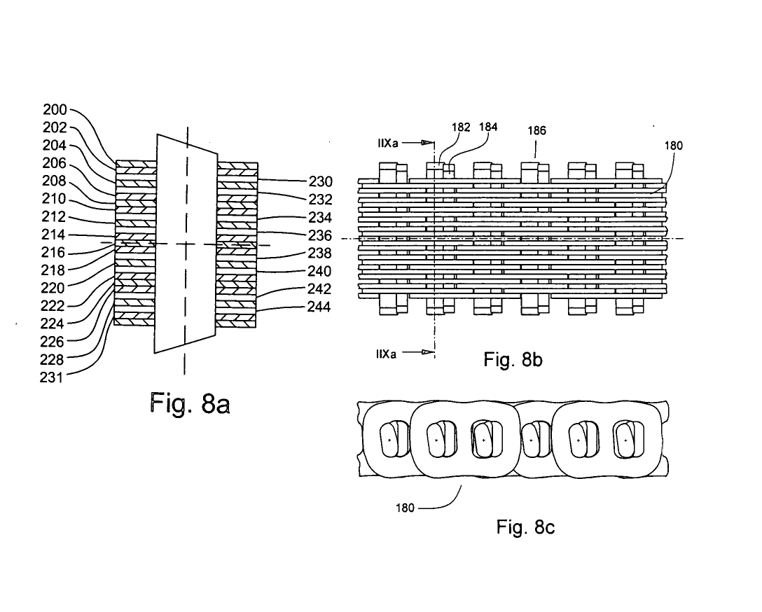

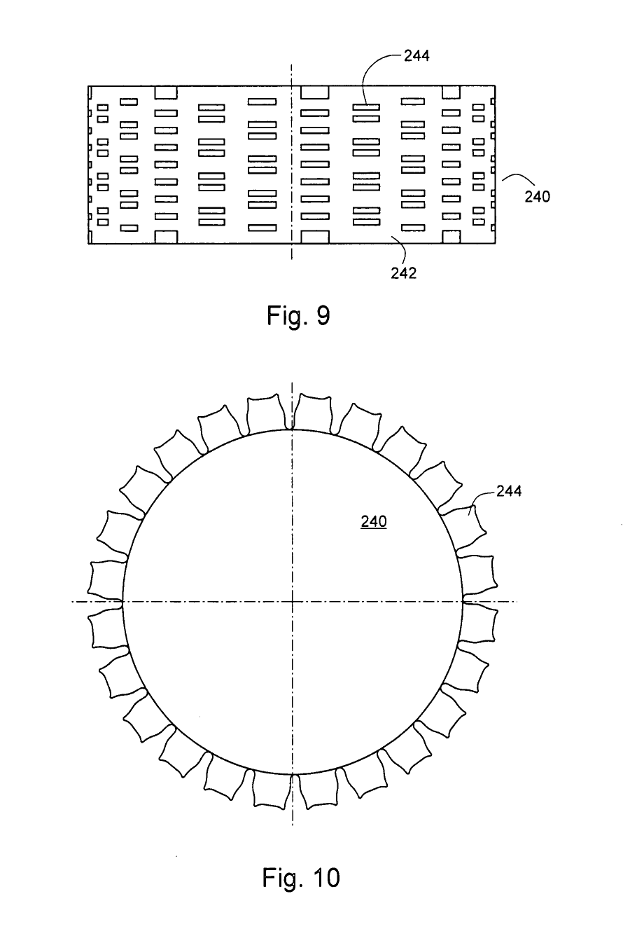

FIG. 9 shows an upper view and FIG. 10 shows a side view of a circle-cylindrical core 240 with fingers 244 protruding from the outer surface 242 thereof; these are not all of them indicated individually with a reference numeral in this FIG. 9. The pattern thereof is such that they fit between the openings which are present between the links, such as shown in FIG. 8b. Such a core with protruding blade-shaped supporting fingers can, for instance, be made by spark erosion.

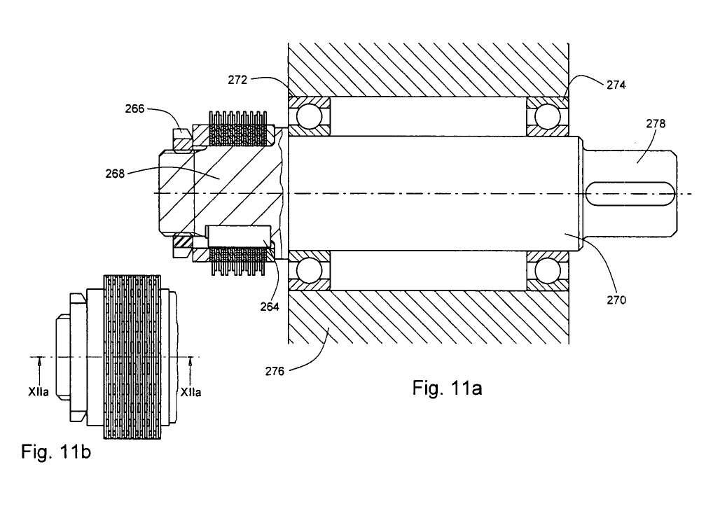

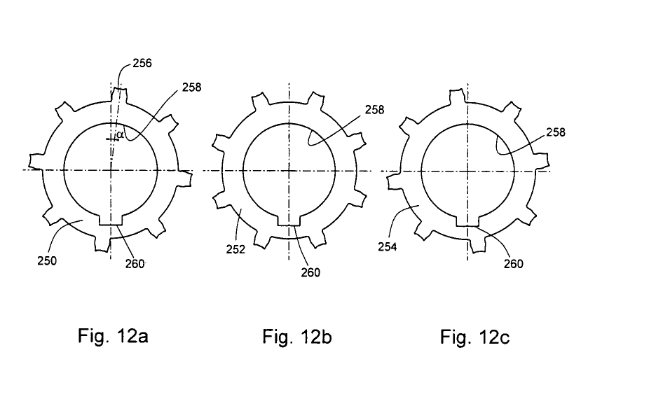

It is, however, also possible to make such a core with protruding blade-shaped supporting fingers as a stack of individual ring-shaped elements with radially protruding bladeshaped fingers in the way as shown in FIGS. 11a-11b and 12a-12c. FIGS. 12a, 12b and 12c show three, generally similar but in detail mutually different rings 250, 252, 254 from thin plate material, each with radially protruding supporting fingers which are not specified individually but which are each indicated with reference numeral 256. Each ring 250, 252, 254 has a cylindrical inner boundary 258 with a square locating cutout 260. As FIG. 11a and 11b show a number of such rings are combined into the stack 262 which is shown in FIG. 11b in upper view and this according to a pattern which corresponds to the pattern of the interspaces in the chain to be preloaded. This stack is, in combination with the key 264 by means of the clamping nut 266 fixed to the end 268 of the shaft 270 which is by means of the bearings 272, 274 supported in a suitable frame 276 and which can be driven in any suitable way at the end 278 of the shaft.

It will be clear that by a suitable choice of the orientation of the fingers 256 around the surface of the ring 250 (a measure of which can for instance be the angle a between the axis 280 of such a finger and the vertical centerline 282 of the ring), any configuration of the link packets can be taken into account, also situations in which there is, as seen in the longitudinal direction of the chain a varying pitch, thus a varying centerline distance between individual pairs of rocker pins.

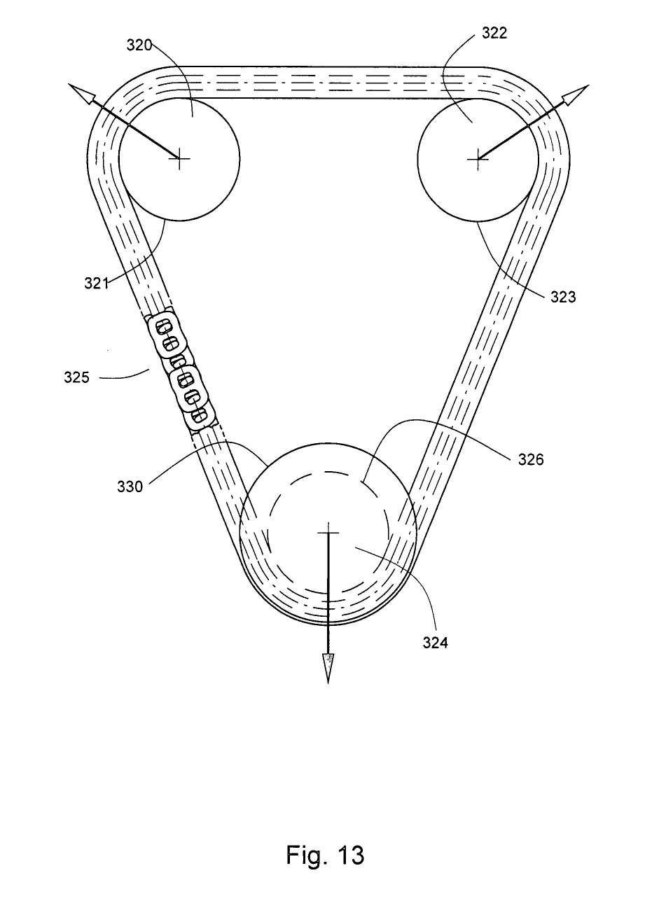

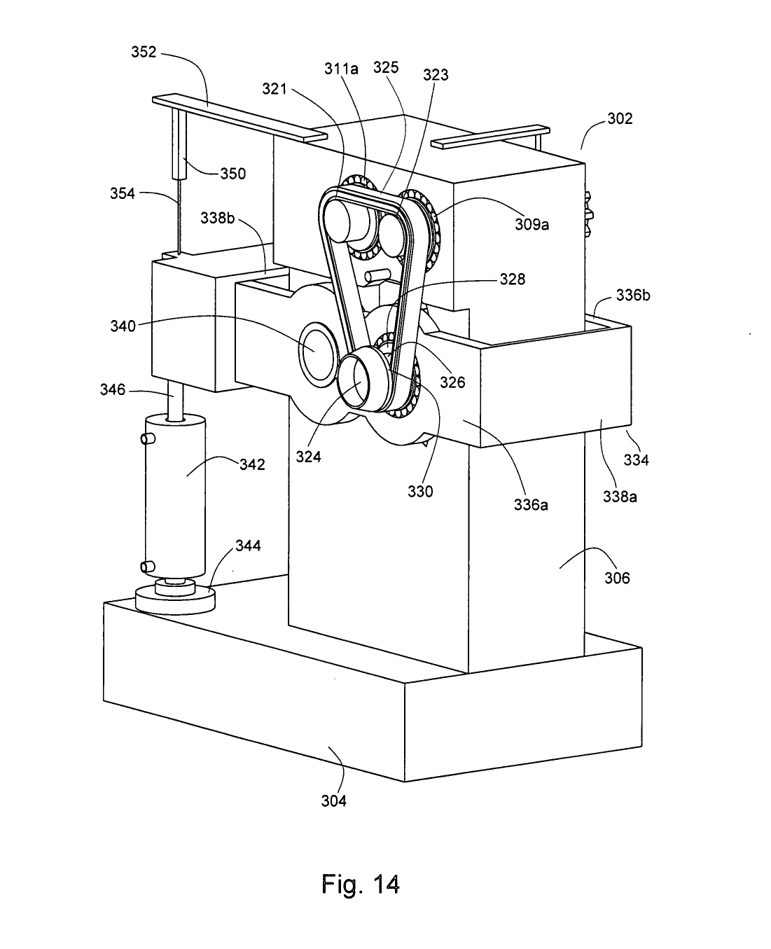

A complete device for stretching a chain in which the above mentioned principles are used is illustrated in FIGS. 13 and 14.

FIG. 13 shows schematically and in end view the configuration used in such an apparatus. There are two upper supporting rollers 320, 322 each with a circle-cylindrical surface and one lower supporting roller 262 which has the configuration as shown in FIG. 6, thus in which the cylindrical supporting surfaces is bounded by two flanges with conical guide surfaces. The chain to be preloaded is indicated with 325.

The apparatus shown in FIG. 14 and indicated in its entirety with reference numeral 302 comprises as base plate 304 and a very stiff, schematically shown, frame 306 with parallellepipedum-shaped outer dimensions. Near the upper end thereof this frame carries two shafts, not indicated with a reference numeral and supported by bearings 309a and 311a in the frame, each having at their end which is visible in the drawing a cylindrical supporting surface 321 and 323 respectively. Below these shafts there is a third shaft 324 with a cylindrical supporting surface 326 bounded by guiding flanges 328, 330 in the way as shown in FIG. 6. This shaft 324 is supported by two suitable bearings (not shown) in a yoke 324 which encloses the frame 306 and has the long sides 336a, 336b which run along the front and rear side of the frame 306 and the short side 338a, 338b. The yoke is supported by the frame 306 by means of the shaft 340. The yoke can tilt over a limited angle around the shaft 340 and is actuated by a linear actuator 342 which acts in two directions and which rests via the pressure sensor 344 upon the base plate 304; the piston rod 346 thereof is coupled to the short side 338b of the yoke 340 as close as possible to the plane of symmetry through the three pairs of supporting surfaces.

Finally there is a displacement sensor 350 which is coupled by means of arm 352 with the frame and by means of the finger 354 with the arm 338b of the yoke 334.

The operation of the device will be clear. By retracting the double acting actuator 342 the displaceable shaft with its corresponding supporting surface will move upwardly and a chain which is to be preloaded can then be mounted around the three respective shafts. Thereafter a controlled supply of hydraulic pressure medium results into an upward movement of the piston rod 346 so that the chain is pretensioned with a predetermined force. Then the initial length of the chain is measured by means of the sensors 350, 354. Finally the piston rod and with it the end 338b of the yoke is pressed upwardly with a greater force so that the shaft which is supported by the yoke moves downwardly and the chain is preloaded while surpassing the limit of elasticity of the links. During this operation the shaft 308 is driven rotatingly by means which are not shown. After this operation the lasting elongation can be measured by means of the sensors 350,354.

It will be clear that the mounting of the chain, the pretension, the measuring of the initial length, the rotatingly driving of the chain and the stretching of the chain can not only be effected manually but also in an automated process during which for each chain the particulars as measured are stored.

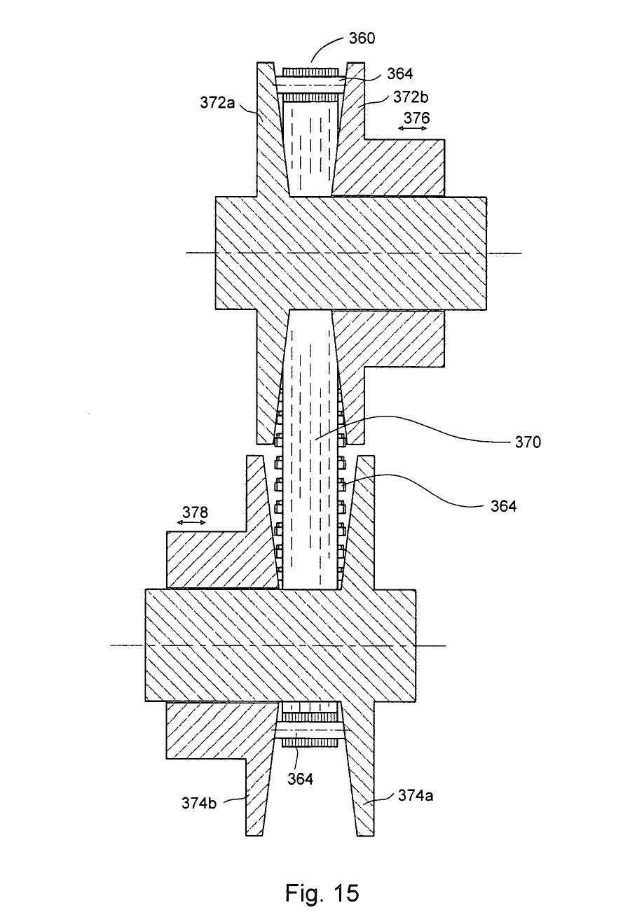

FIG. 15 shows schematically the known way in which a transmission chain according to the invention, in this case the chain 370, cooperates with the conical surfaces of the pulley sheaves 372a, 372b; 374a, 374b of a continuously variable transmission. As shown the ends of the pins 364 are clamped between these surfaces. The pulleys 372a, 372b can, for instance, be the driving pulleys while the chain 370 transmits a torque via the pins 364 and the links 360 to the driven pulleys 374a,374b. The axial position of the conical sheave 3721) is controlled by a (not shown) actuator which moves this sheave in the direction of the arrows 376 while the axial position of the conical sheave 374b is controlled by a (not shown) actuator which moves the sheave in the direction of the arrows 378. The respective movements are such that, when one sheave moves to the left (in the drawing) the other moves to the right, and opposite so that the chain 370 remains centered.

What is claimed is:

1. A device for stretching a continuous transmission chain having a number of adjacent links which are intercoupled in the longitudinal direction of the chain by pairs of longitudinal rocker elements in which the respective ends of at least one rocker element can cooperate in a torque transmitting way with pulley sheaves of a pulley sheave transmission, 5 said device comprising:
at least one first and one second supporting surface which lie at a distance from each other, support a chain to be treated at least partially along an arcuate path, and means to generate in the chain tensile stresses of such magnitude that the limit of elasticity of the material of the links is at least locally surpassed,
wherein at least one of the supporting surfaces is configured to support the radial inner area of at least a part of the chain, such that essentially only stresses directed in the longitudinal direction of the respective links are generated in these links.

2. The device according to claim 1, in which at least one supporting surface is configured to support the radial inner edges of at least a part of a number of links.

3. The device according to claim 1, in which at least one supporting surface is configured in such a way that a link with a hollow end edge configuration is supported in two points on this end edge which lie at a distance from each other.

4. The device according to claim 1, in which at least one supporting surface is at least a part of the outer surface of a circle-cylinder.

5. The device according to claim 4, in which this outer surface is convexly curved.

6. The device according to claim 4, in which this outer surface is concavely curved.

7. The device according to claim 2, in which the outer surface is bounded by two radially guiding flanges at a distance of each other, extending substantially up to the ends of the rocker elements of a chain to be treated.

8. The device according to claim 2, in which the at least one supporting surface is comprised of a number of adjacent supporting surfaces is formed into one common support.

9. The device according to claim 1, in which at least one supporting surface is built up from a number of partial surfaces, each configured to support at least a part of the radial inner end edge of at least one rocker element of each pair of a number of adjacent rocker 30 elements as seen in the longitudinal direction of the chain.

10. The device according to claim 9, in which each partial surface is made up from an end edge of a plate-shaped finger of which the thickness is adapted to the interspace which is present between adjacent links, said finger, in combination with a number of similar fingers, protrudes radially from the outer surface of a common rotatingly supported bearer, 35 wherein the positioning pattern of these fingers is adapted to the configuration of the link packets of the chain.

11. The device according to claim 10, in which the fingers and bearer constitute one common part.

12. The device according to claim 10, in which the respective blade-shaped fingers each protrude from the outer circumference of a ring-shaped bearer plate, wherein a number 5 of these ring-shaped bearers plates together with interpieces of suitable thickness are stacked into a unit which is carried by a central shaft.

13. The device according to claim 10, in which the circumferential distance between the centerlines of adjacent fingers is adapted to the predefined distribution of the pitch of a chain to be treated.

14. The device according to claim 1, in which the supporting surfaces are stationary during operation of the device.

15. The device according to claim 1, in which at least one of the supporting surfaces is carried by a bearer which can rotate around a central axis.

16. The device according to claim 1, in which the distance between the first and 15 second supporting surfaces can be adjusted to generate defined tension forces in the links of a chain to be treated.

17. The device according to claim 1, comprising three supporting surfaces, of which the respective centers lie on the corners of a substantially isosceles, triangle.

18. The device according to claim 1, in which two centering elements are positioned 20 at both sides along the path of movement of a chain to be treated.

19. The device according to claim 18, in which the centering elements comprise guide wheels of which the axis of rotation is perpendicular to the path of the chain.

20. A method for stretching a continuous transmission chain having a number of adjacent links which are intercoupled in the longitudinal direction of the chain by pairs of 25 longitudinal rocker elements in which the respective ends of at least one rocker element can cooperate in a torque transmitting way with the pulley sheaves of a pulley sheave transmission, comprising the steps of:
(a) using at least one first and one second supporting surface which lie at a distance from each other to support a chain to be treated at least partially along an arcuate path, and (b) generating in this chain tensile stresses of such magnitude that the limit of elasticity of the material of the links is at least locally surpassed while supporting the radial inner area of at least a part of the chain.

21. The method according to claim 20, in which the inner end edges of a number of links adjacent each other in the longitudinal direction of the chain are supported according to 35 an arcuate surface.

22. The method according to claim 20, in which at least part of the respective inner end edges of at least one rocker element of each pair are supported according to an arcuate supporting configuration.
